(19) United States
(12) Patent Application Publication
(10) Pub. No.: US 2019/0263558 A1
(43) Pub. Date: Aug. 29, 2019

(54) A BLOW-MOLDED PANEL FOR A STORAGE CONTAINER

(71) Applicant: Plant IP Pty Ltd, Portsmith, Cairns (AU)

(72) Inventors: Gary Raymond PLANT, Cairns (AU); Ronald RAE, Pacific Pines (AU); Guanwen WANG, Chengdu (CN)

(21) Appl. No.: 16/318,943

(22) PCT Filed: Jul. 18, 2017
(86) PCT No.: PCT/AU2017/050741

§ 371 Date: Jan. 18, 2019

(30) Foreign Application Priority Data
Jul. 18, 2016 (CN) 201620755064.7
Jul. 18, 2016 (CN) 201620755069.X
Jul. 18, 2016 (CN) 201620755624.9
Jul. 18, 2016 (CN) 201620756064.9
Jul. 18, 2016 (CN) 201620756333.1
Jul. 18, 2016 (CN) 201620757052.8
Jul. 18, 2016 (CN) 201620757940.X
Jul. 18, 2016 (CN) 201620758226.2
Jul. 18, 2016 (CN) 201620758840.9

(51) Int. Cl. B65D 6/24; B60R 5/04; B29C 49/00

(52) U.S. Cl. CPC B65D 11/1873; B29C 49/0031; B60R 5/04

(57) ABSTRACT

A blow-molded plastic panel 23 is for a flat-packable storage container 10. At least a portion 236 of the panel 23 has a substantially planar extent. The panel portion 236 has first and second outer wall surfaces substantially aligned with the substantially planar extent of the panel portion 236. One or more cavities 233 lies between the first and second outer wall surfaces. The panel portion 236 is provided with a plurality of recesses 237 in the first outer wall surface which are recessed in the direction of the second outer wall surface. The recesses 237 are spaced longitudinally and transversely relative to the substantially planar extent of the panel portion.

### FIELD OF THE INVENTION

The present invention relates to a blow-molded plastic panel for a flat-packable storage container. In particular, although not exclusively, the invention relates to a blow-molded panel for a vehicle-mounted storage unit. The invention also relates to a storage unit assembled from blow-molded plastic panels.

### BACKGROUND OF THE INVENTION

Vehicle-mounted storage boxes have become popular to store articles by category and make the car trunk tidier. They are particularly useful for long journeys or outdoor adventures for which you need to carry a large quantity of necessities. They have particular application for recreational vehicles such as 4 wheel-drive vehicles which are widely used for outdoor recreational activities.

In the past, the storage boxes were typically composed of metal plates and thus very heavy. Solutions to this problem using panels made of plastic have reduced the weight of the storage box. However, known solutions are poor in bearing capacity and easily deform under loading.

Thus, it is an object of the present invention to provide a blow-molded plastic panel which overcomes or ameliorates the abovementioned disadvantages. Another object of the present invention is to provide the public with a useful choice over known blow-molded plastic panels for vehicle-mounted storage units.

Reference to any prior art in the specification is not an acknowledgment or suggestion that this prior art forms part of the common general knowledge in any jurisdiction or that this prior art could reasonably be expected to be combined with other pieces of prior art by a skilled person in the art.

### SUMMARY OF THE INVENTION

In accordance with a first aspect of the present invention, there is provided, a blow-molded plastic panel for a flat-packable storage container, at least a portion of said panel having a substantially planar extent, the panel portion having first and second outer wall surfaces substantially aligned with the substantially planar extent of the panel portion,

wherein one or more cavities lies between the first and second outer wall surfaces, and

the panel is provide with a plurality of recesses in the first outer wall surface which are recessed in the direction of the second outer wall surface, said recesses being spaced longitudinally and transversely relative to the substantially planar extent of the panel portion.

The panel is preferably provided with a first wall and a second wall, which in the blow-molding process are molded in generally spaced disposition from each other. The first wall provides the first outer wall surface and the second wall provides the second outer wall surface. The first and second walls may meet at the recesses. In such case, the first and second walls may be indivisible or indistinguishable at that location through being bonded or united through the blow-molding process. Alternatively, the first and second walls may be spaced apart with a clearance provided at the recesses.

Further, said recesses may be arranged in a regular array on or across the substantially or generally planar extent of the panel portion. For example, the recesses may be arranged as a rectangular array with a number of transverse and longitudinal rows of recesses. This may define a transverse or longitudinal ridge between any two of the transverse or longitudinal recess rows. The spacing between the transverse or longitudinal arrays may be uniform spacing. Further, the said transverse ridges may have the same width as said longitudinal ridges. In addition to low weight, the recess array forms transverse and longitudinal ridges on the hollow structure, which greatly improve the bearing capacity of the panel.

Alternatively, the recesses may be arranged more irregularly on the substantially or generally planar extent of the panel portion, such as being scattered on or across the panel portion. The recesses may be arranged across the full extent of the panel portion. The first outer surface of the panel portion could have a dimpled appearance.

The recesses on the first surface of the panel portion may be replicated on the second surface of the panel portion. For example, the recesses on the first surface of the panel portion may meet with corresponding recesses on the second surface of the panel portion. This produces a waffled effect.

The recesses in the panel portion may be of any shape. They may all be of uniform shape or they may vary in shape. Preferably, each recess is approximately rectangular in shape. Preferably, the transverse extent which is shorter than the longitudinal extent, is oriented such that it is subject to loading in use. In a most preferred form, each recess is rectilinear with rounded ends, such as a slotted shape. The outer edges of the recess may be beveled.

Preferably, the first outer wall surface, apart from the recesses is substantially flat.

At one or more of the recesses, the distance between the first and second wall surfaces may be relatively thin. This may allow for easy removal of material therebetween for ventilation or cabling. Easy removal may permit removal by hand such as by simple manual pressing, or with a hand tool such as a knife or punch.

Some of the recesses of a panel portion may have a detachable portion. Such recesses may be specially designed for easy removal or detachment of the detachable portion. For example, there may be a smaller distance between the first and second wall surfaces as compared to other recesses in the panel portion. The detachable portions may be bordered by a score line, a groove or a notched line. Such recesses may be indicated or marked as having this special form and/or function. For example, such recesses may have a different appearance to the other recesses such as a different shape, marking or may be grouped in a particular location. The end user may selectively remove the material or the task may be completed at the factory.

The panel is constructed of plastic material. The panel portion may be one of a plurality of panel portions which are unitarily molded into the one panel. Where there are a plurality of panel portions, the recesses in one panel portion may have detachable portions while the recesses in other panel portions may not be intended to be detachable.

Alternatively, the panel may have a single panel portion.

In the blow-molded panel there may be a second panel portion having a substantially planar extent, the second panel portion having third and fourth outer wall surfaces substantially aligned with the substantially planar extent of the second panel portion,

wherein the second panel portion is provided with a plurality of recesses in the third outer wall surface which are recessed in the direction of the fourth outer wall surface, said recesses being spaced longitudinally and transversely relative to the substantially planar extent of the second panel portion. The recesses in the second panel portion may have removable portions. The cavity of the first panel portion may be shared with the cavity of the second panel portion.

In another aspect of the invention, a storage unit may be made up of a plurality of panels as described above in the first aspect. Some of the recesses in the storage unit may have detachable portions. The recesses having detachable portions may be grouped. Preferably, the grouping is in the rear of the storage unit for ventilation of a refrigeration unit housed in the storage unit.

It will be understood that the invention disclosed and defined in this specification extends to all alternative combinations of two or more of the individual features mentioned or evident from the text or drawings. All of these different combinations constitute various alternative aspects of the invention.

### BRIEF DESCRIPTION OF THE DRAWINGS

FIG. 1 is a front perspective view of an ancillary storage unit for a vehicle according to a preferred embodiment of the present invention;

FIG. 2 is a perspective view of the storage unit of FIG. 1 with the drawers open;

FIG. 3 is a perspective view of the storage unit shown in FIG. 2 with a refrigerator housed in the large drawer;

FIG. 4 is a perspective view of the carcass of the storage unit of FIG. 1, without the drawers;

FIG. 5 is a rear perspective view of the carcass of FIG. 4;

FIG. 5A is a fragmentary cross-section depicting how the storage unit is located in position in a rear compartment of a vehicle;

FIG. 6 is an exploded perspective view of the carcass of FIG. 4;

FIG. 7 is an exploded perspective view of the top panel and support beams of the carcass of FIG. 4;

FIG. 8 is an exploded perspective view of the telescopic support beams of FIG. 7;

FIG. 9 is an exploded perspective view of the fastener assembly to assemble the top panel and support beams together;

FIG. 10 is an exploded perspective view of the extension panel of the carcass shown in FIG. 4;

FIG. 11 is a detailed view of the tenon projection provided on the upright divider panels of the carcass of FIG. 4;

FIG. 12 is a perspective view of the mortise hole provided in the top panel, bottom panel and rear panel of the carcass shown in FIG. 4;

FIG. 13 is a front perspective view of the rear panel of the carcass shown in FIG. 4;

FIG. 14 is a rear profile view of the rear panel shown in FIG. 13;

FIG. 15 is a cross sectional view along A-A of the rear panel shown in FIG. 14;

FIG. 15A is a detailed cross-sectional view of FIG. 15;

FIG. 15B is a cross-sectional detail of the divider panel of the carcass of FIG. 4;

FIG. 16 is a front perspective view of the large drawer of the storage unit shown in

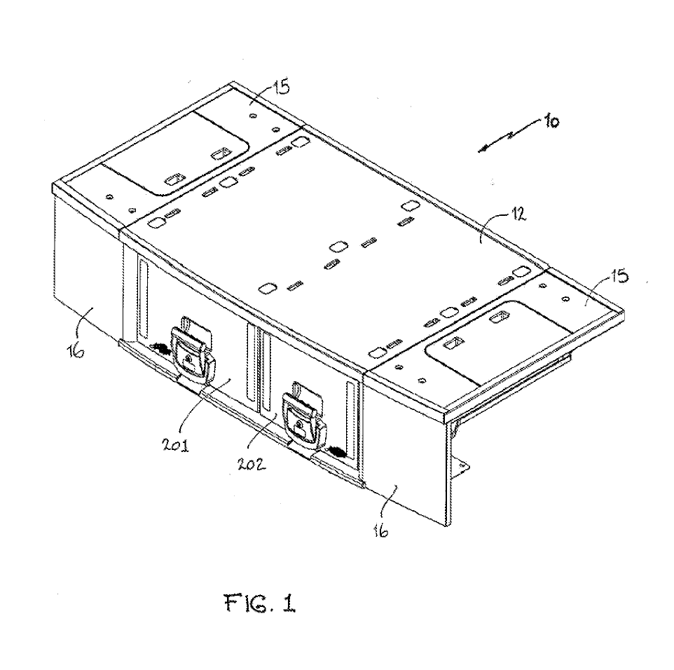

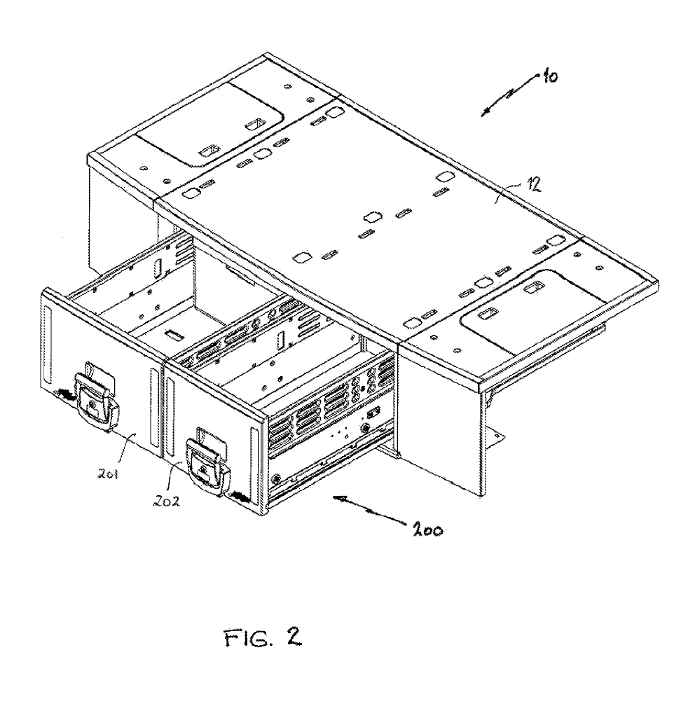

FIG. 1;

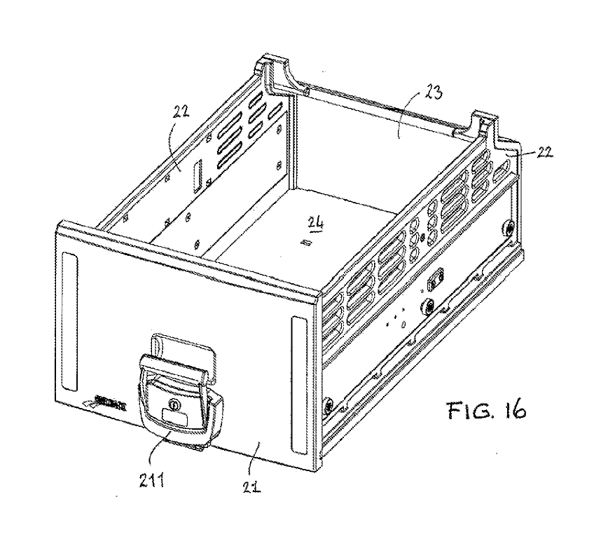

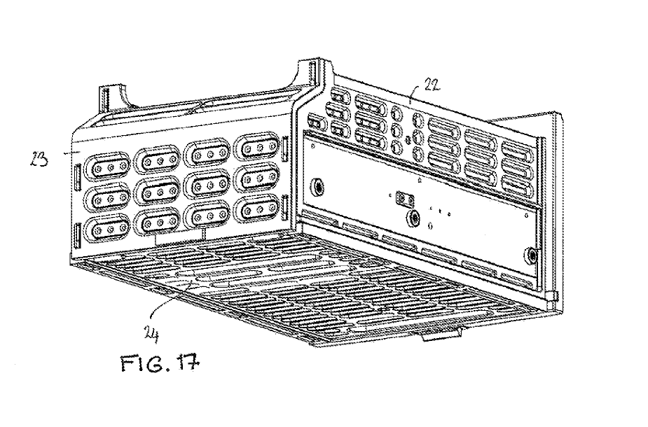

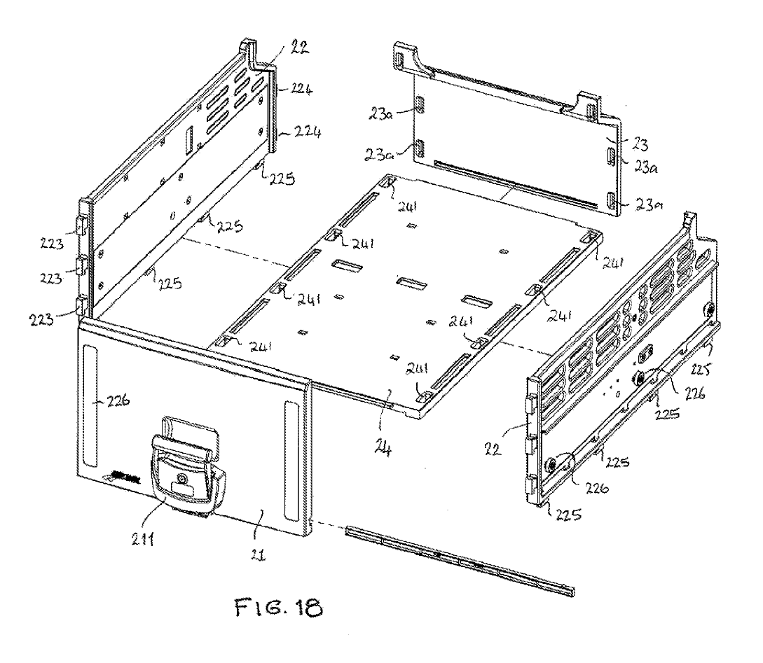

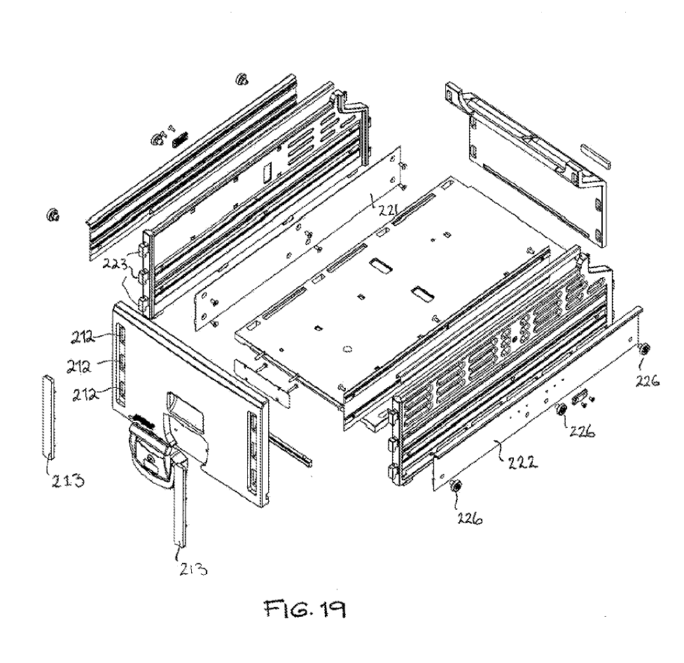

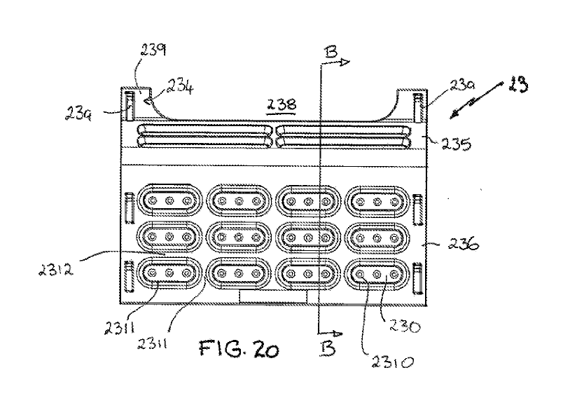

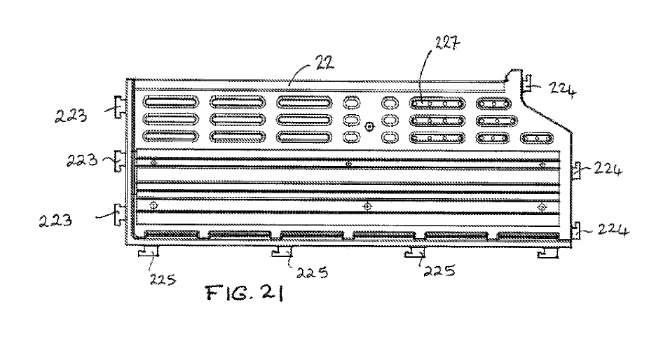

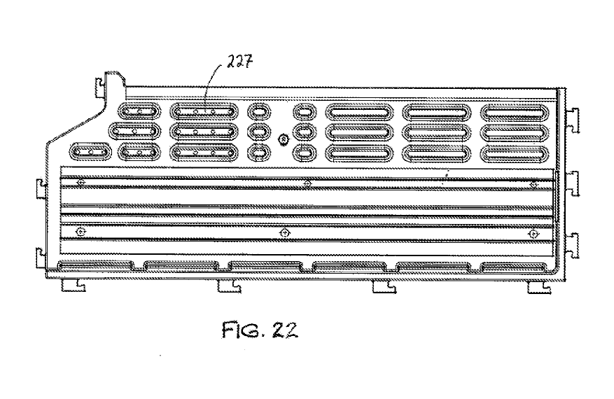

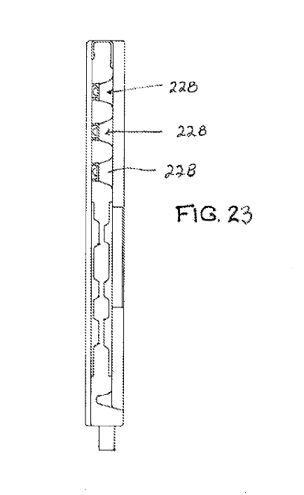

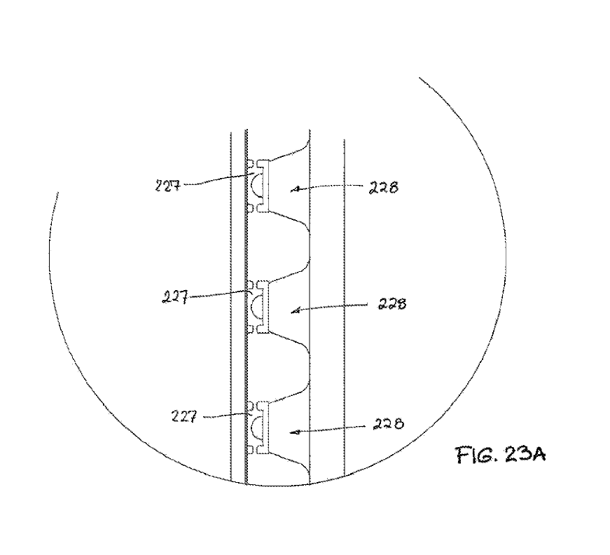

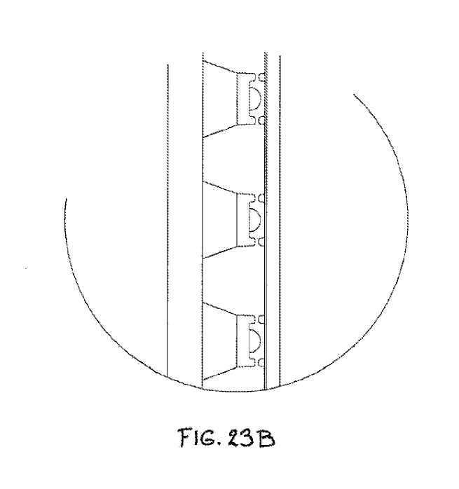

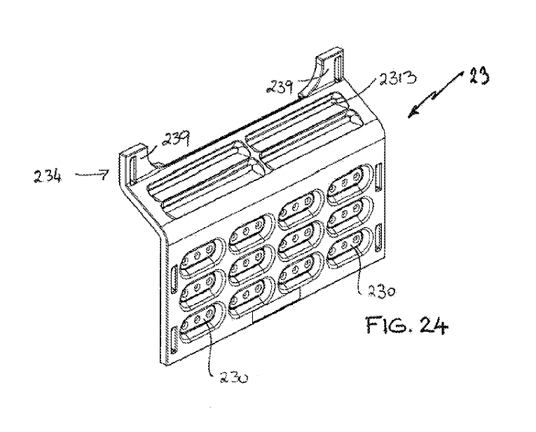

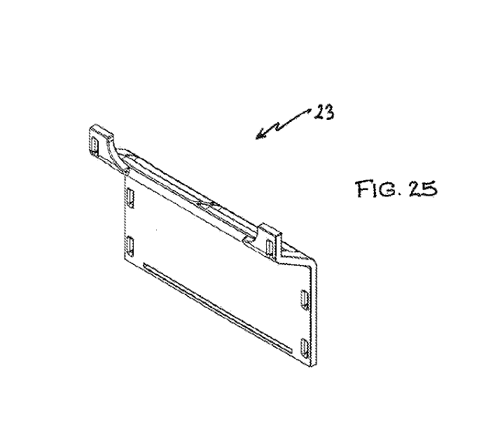

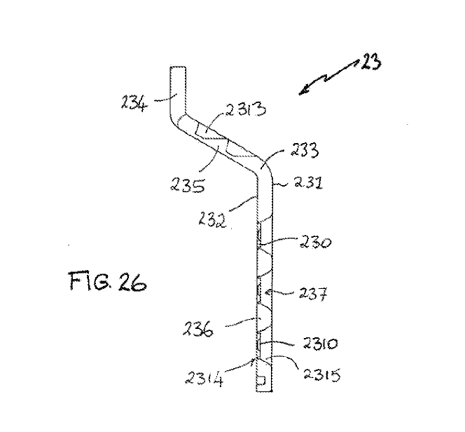

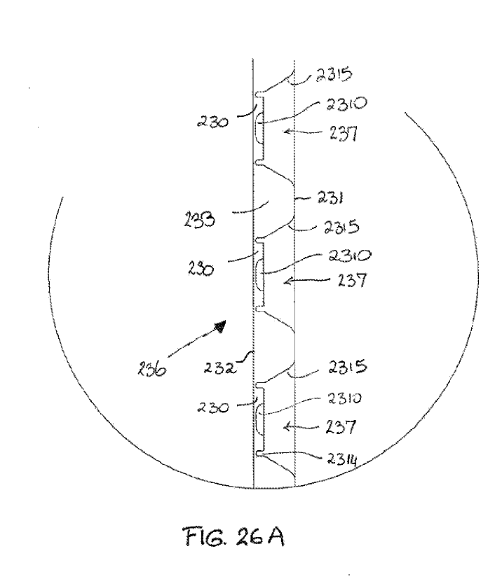

FIG. 17 is a rear perspective view of the large drawer shown in FIG. 16;

FIG. 18 is an exploded view showing the panels of the large drawer of FIG. 16;

FIG. 19 is an exploded view of the large drawer of FIG. 16, including the drawer mounts for sliding movement of the drawers;

FIG. 20 is a rear profile view of the rear panel of the drawer of FIG. 16;

FIG. 21 is a profile view of the right hand side panel of the large drawer of FIG. 16;

FIG. 22 is a profile view of the left hand side panel of the large drawer;

FIG. 23 is a cross sectional view through the left hand side panel of FIG. 22;

FIG. 23A is a detailed cross sectional view of FIG. 23;

FIG. 23B is a detailed cross sectional view of the right hand side panel of FIG. 21;

FIG. 24 is a rear perspective view of the rear panel of the large drawer;

FIG. 25 is a front perspective view of the rear panel of the large drawer;

FIG. 26 is a cross sectional view through the rear panel of the large drawer;

FIG. 26A is a detailed cross sectional view of FIG. 26.

### DETAILED DESCRIPTION OF THE EMBODIMENTS

The figures show a multipurpose vehicle-mounted storage unit 10 which is made up of flat-packable panels which are substantially planar or plate-like. The panels may be shipped to the end user in a flat-pack for do-it-yourself assembly by the end user. The panels and the assembly features provided thereon, also lend themselves to being de-constructed as desired by the end-user for lower volume storage. The panels make up a carcass 101 to accommodate a number of drawers. The drawers are also constructed from flat-packable panels.

As shown in FIGS. 4 to 6, the storage unit 10 has a carcass 101 comprising a rear panel 11, a horizontally arranged top panel 12 and bottom panel 13, and several upright divider panels 14 uprightly placed between the top panel 12 and bottom panel 13. The panels 11, 12, 13 and 14 are all fabricated using the construction technique of blow-moulding of plastics material e.g. polypropylene to produce hollow panels as will be described further below.

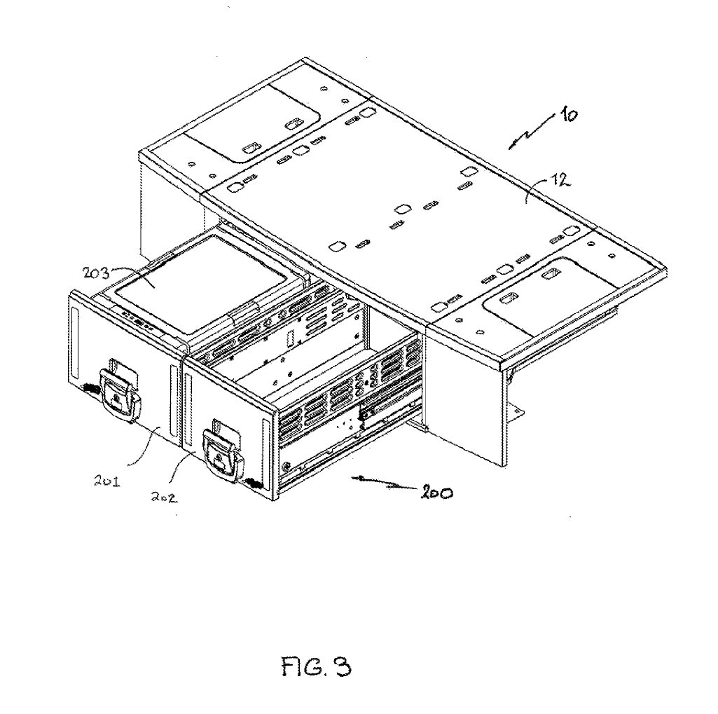

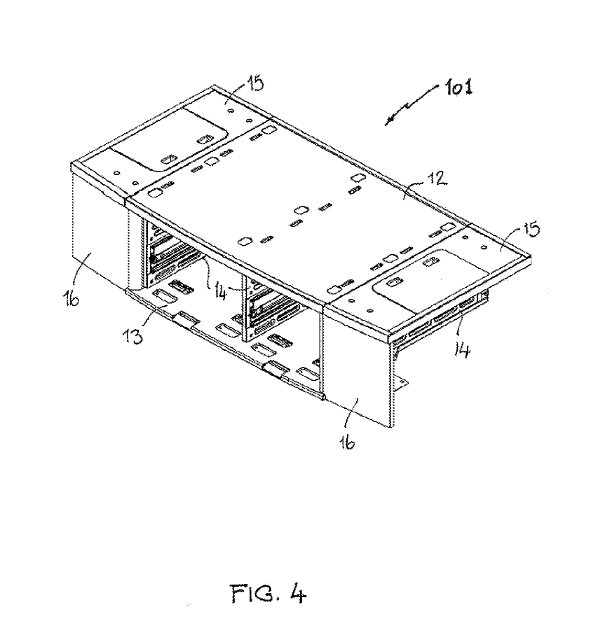

The bottom panel 13, top panel 12, and rear panel 11 are connected to the divider panels 14 with mortise-tenon joints, thus forming two side-by-side storage compartments used for placing drawers 200 as shown in FIGS. 1 to 3. When the unit 10 is installed, these compartments open towards the same direction as the opening of the vehicle (not shown).

### Support Beams

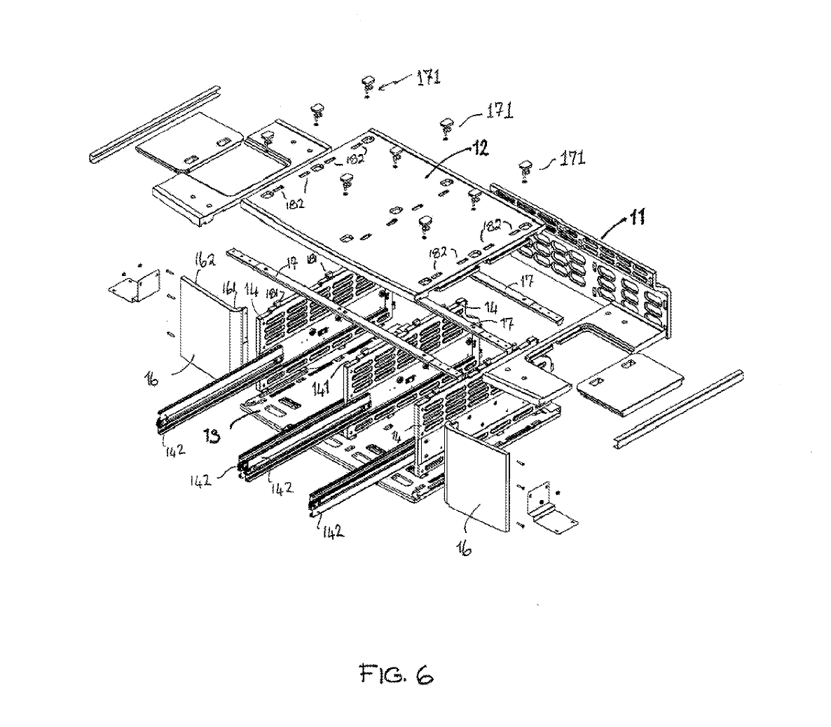

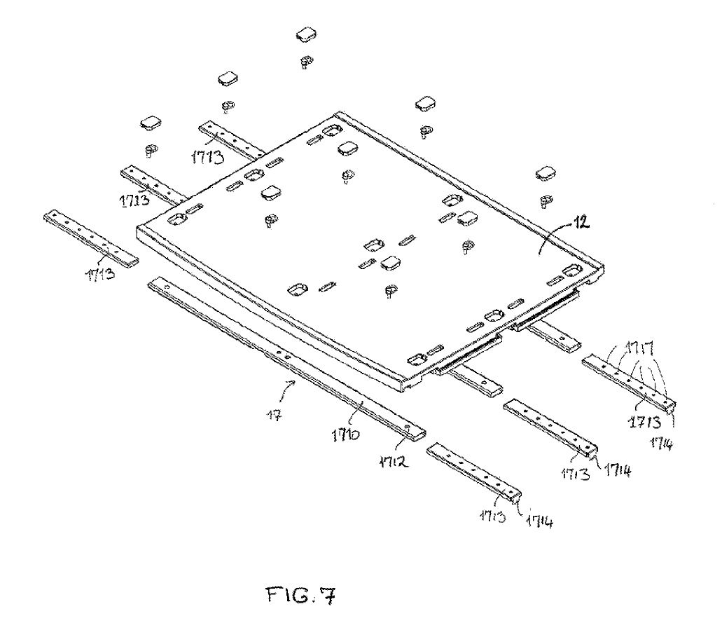

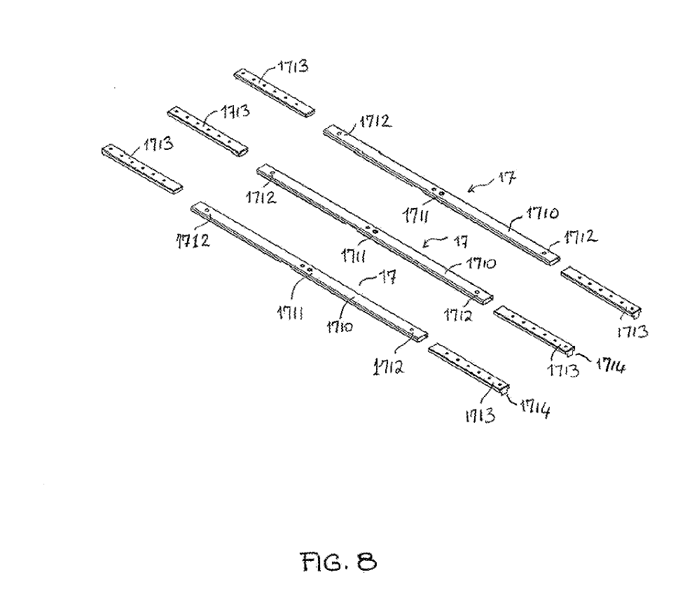

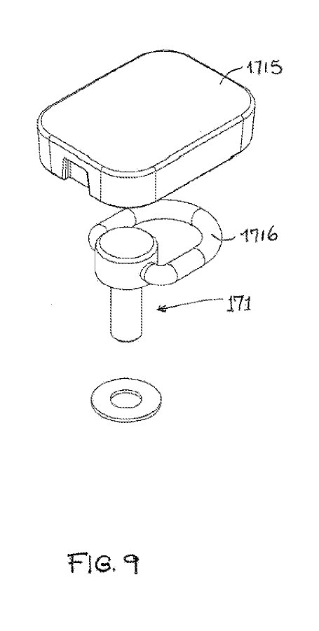

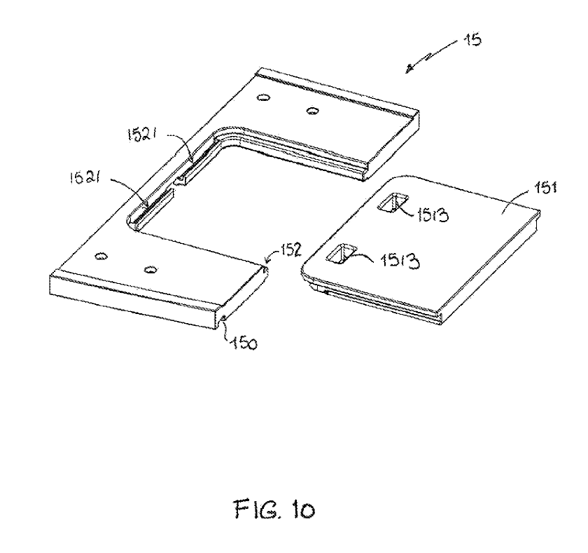

As shown in FIGS. 6 to 8, three support beams 17 are placed upon the upper edges of the divider panels 14 and received in complementary recesses provided on the underside of the top panel 12. The top panel 12 is fixed to the beams 17 with fastenings 171. The beams 17 increase the rigidity of the top panel 12.

As shown in FIG. 9, each fastening 171 passes through the top panel 12. As shown in FIG. 6, there are 3 rows of fasteners 171 spaced across the top panel 12. The central row of fasteners 171 are fixed in the fastening screw holes 1711 which are threaded holes provided in the beams as shown in FIG. 8. At the outer edges of the top panels, the fasteners 171 seat into the extension pieces 1713 to provide adjustment of the extension pieces 1713 as will be explained below.

As shown in FIG. 9, a dust cap 1715 is placed on the top of the fastener 171. A fastening ring 1716 that is convenient for manual handling is provided on the fastener 171, and the dust cap 1715 is provided with a cavity (not shown) on its underside for containing the fastening ring. The ring 1716 enables users to manually adjust the tightness of the fastener 171 without the help of any tools, and the dust cap 1715 prevents dust and dirt from entering into the fastener 171 and the fastening screw hole 1711 and thus protects them from rust and other damage to prolong their service life. Each ring 1716 can also be useful as a tie-down anchor point on top of the storage unit.

Referring to FIGS. 7 and 8, the support beams 17 are each comprised of a central flattened aluminium tube 1710 of approximately rectangular cross-section which is able to receive extendible and retractable extension pieces 1713. The extension pieces 1713 are inserted into each end of the tube 1710. The extension pieces 1713 are of approximately rectangular cross-section and of a size which allows for easy sliding within the tube 1710. The extension pieces 1713 are of plastic and preferably of a kind which allows for easy sliding between the extension piece and the tube, e.g. glass filled nylon. The end of the extension piece 1713 is provided with a stopper 1714 to define the limit of retraction of the extension piece 1713 into the tube 1710.

As can be seen, the end of the tube 1710 is provided with a hole 1712 which allows passage of the fastener 171 therethrough. Each extension piece 1713 is provided with a series of spaced adjustment holes 1717 which are threaded and allow adjustment of the extension/retraction of the extension pieces 1713 beyond the ends of the tubes 1710.

The telescopic beams 17 permit the overall width of the unit 10 to be reduced for easy removal from the rear of the vehicle. Generally the width of the opening of a vehicle such as the boot opening, hatch or tailgate is less than the width inside the vehicle so this feature allows easy removal of the unit 10 from the vehicle.

### Sundries Compartment

As shown in FIGS. 1-5 and FIG. 10, extension panels 15 that are flush with the top panel 12 are fixed to the beams 17 at the ends of both beams 17. On each side of the carcass 101, the extension panel 15, the inner wall of the vehicle body (not shown) and the adjacent divider panel 14 form a sundries compartment which is convenient for holding tools and articles. The extension panel 15 increases the flat extent of the top surface of the unit and makes it feasible to place luggage and other objects on top of the storage unit.

The extension panel 15 has a U-shaped opening and is provided with a removable access panel 151 in the opening.

As shown in FIG. 10, the access panel 151 has a complementary profile to the U-shaped opening in the extension panel. In particular, the U-shaped opening has a ledge 152 below its top surface to seat the access panel 151 on the seat with the top surface of the access panel 15 flush with the top surface of the extension panel 15.

The access panel 151 is removably secured to the extension panel 15 through a grooved connection. There is a connecting groove 1521 on the inner edge of the U-shaped opening. The access panel 151 is designed with a connecting tongue (not shown) on its corresponding edge, and the tongue can be downwardly inserted into the connecting groove 1521. The connecting groove 1512 and tongue connection prevents the access panel 151 from coming off the extension panel 15 due to car vibration. The access panel is so firmly attached that it can be taken off only by application of manual force.

The access panel 151 is provided with through holes or indentations 1513 for manual handling. Opening or closing of the access panel 151 can be realized by lifting it up or pushing it back down.

As shown in FIGS. 1, 4 and 6, at the front of each sundries compartment, front panels 16 are fixed to the divider panels 14 on both sides of the unit 10. The upper edge of the front panel 16 is fixed to the top panel 12 and extension panel 15 through a grooved connection, and the lower edge is fixed to the bottom panel 13 through a grooved connection.

The front panel 16 is composed of a curved segment 161 and a flat baffling segment 162, which are unitarily molded in one piece. The curved segment 161 is fixed to the outer side of the divider panel 14, and installed into two arc-shaped grooves 120 on the undersurface of the top panel 12 and the top surface of the bottom panel 13, which are consistent with the curved segment 161 in shape.

The upper edge of the baffling segment 162 is fixed to the underside of the extension panel 15 through a grooved connection. There is a straight groove 150 (see FIG. 10) on the underside of the extension panel 15, which matches with the upper edge of the baffling segment 162, and the upper edge of the baffling segment 162 is embedded in the straight groove 150.

The curved segment 161 is convenient for fixing the front panel 16 to the divider panel 14, and the baffling segment 162 keeps the front of the unit flat. The front panel 16 can prevent articles in the sundries compartment from falling out and further improve the effectiveness of space partitioning.

The sundries compartment can be used for storing car repair tools. The detachable access panel 151 not only is convenient for looking for things, but also can prevent the tools from jumping out of the compartment and improve the tidiness of the car trunk.

### Mortice-Tenon Joints

As shown in FIG. 6, the upper edges, lower edges, and rear edges of all the divider panels 14 are provided with aligned tenons 181, and the bottom panel 13, top panel 12, and rear panel 11 are all provided with mortises 182 at the corresponding positions. The tenons 181 mate with the mortises 182 to form a roughly cuboid structure of the carcass 101. It is very easy to assemble the panels with mortise-tenon joints. When not in use, the carcass 101 can be disassembled for easy storage, thus giving users more autonomy and flexibility.

The mortises 182 are all of the same form and the tenons 181 are also all of the same form throughout the unit 10. The tenons 181 are integrally molded with the associated divider panel 14. Likewise, the material surrounding the mortices i.e. the mortise surrounds, are integrally molded with the associated panel.

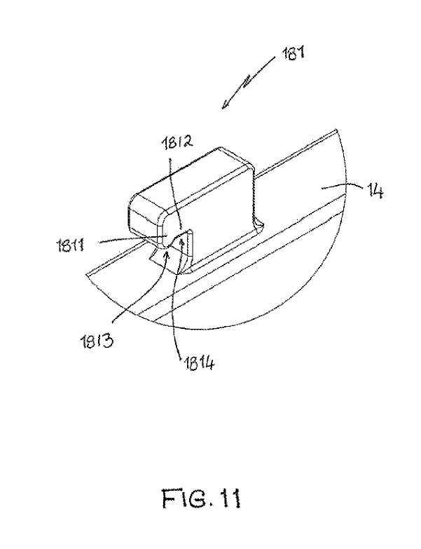

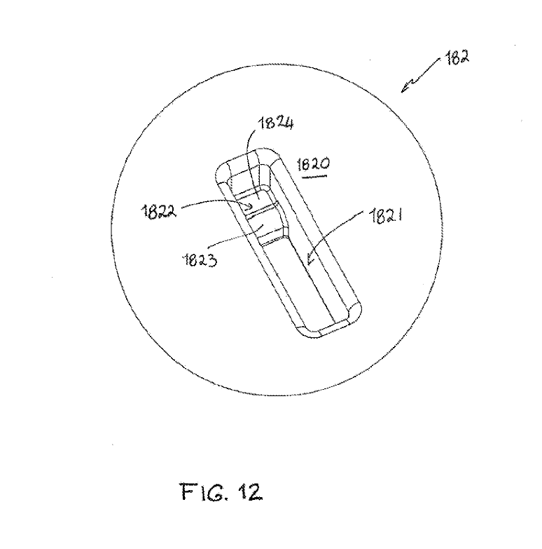

As shown in detail in FIG. 11, the tenon 181 is formed as a projection extending from the panel, in line with the general plane of the divider panel 14. The tenon 181 has a hook profile. A distal portion 1811 of the tenon 181 defines a return 1813 which is closer to the panel 14 compared to an undercut 1814 on an adjacent less-distal portion 1812.

As shown in FIG. 12, the mortice surround 1820 defines a slotted mortice hole 1821 and cooperates with the hook profile of the tenon 181. The mortice surround 1820 defines a barrier portion 1822 such as an overhang, that partly blocks the mortice hole 1821. The barrier portion 1822 has a profiled face which faces away from the tenon 181 as the tenon 181 is being inserted into the opening.

The portion of the mortice hole 1821 which is not blocked by the barrier portion is sized to comfortably receive the tenon 181 or alternatively, the tenon 181 may require a force to bend the distal portion 1811 of the tenon to force the tenon through the mortice hole. However, the second alternative makes the unit difficult to disassemble.

The profiled face of the barrier portion is complementary to the hook profile of the tenon 181. The profiled face defines a ledge or bump 1823, and an indent 1824. The return 1813 on the distal portion 1811 of the tenon 181 is received in the indent 1824 when the tenon 181 is pushed to the home position. The relative dimensions and shapes are such that the tenon must resiliently deform slightly to travel up and over and thereby clear the ledge or bump 1823. Sufficient force must be applied to cause the deformation as the two parts slide relative to each other. The result is a snap action engagement of the return 1813 of the tenon 181 in the indent 1824 when the tenon 181 is pushed to the home position, that can be released only by insertion of a suitable pronged tool. The ledge or bump 1823 is retained in the undercut 1814 of the less-distal portion 1812.

The depth of the indent 1824 is preferably half as much as that of the top panel 12, bottom panel 13, or the rear panel 11.

Preferably, the junction between the profiled face of the barrier portion 1822 and the side wall of the mortise surround 1820 is designed as smooth arc surfaces during manufacture.

Likewise, the profiled face of the barrier portion 1822 including the indent 1824 and the ledge or bump 1823 is designed as smooth arc surfaces. Additionally the return portion 1813 and the undercut 1814 of the hook portion are designed as smooth arc surfaces. This design makes the contact surface between each mortice hole and tenon projection smooth, and the user can effortlessly finish the assembly. In addition, the design can reduce friction between components and prolong the product's service life.

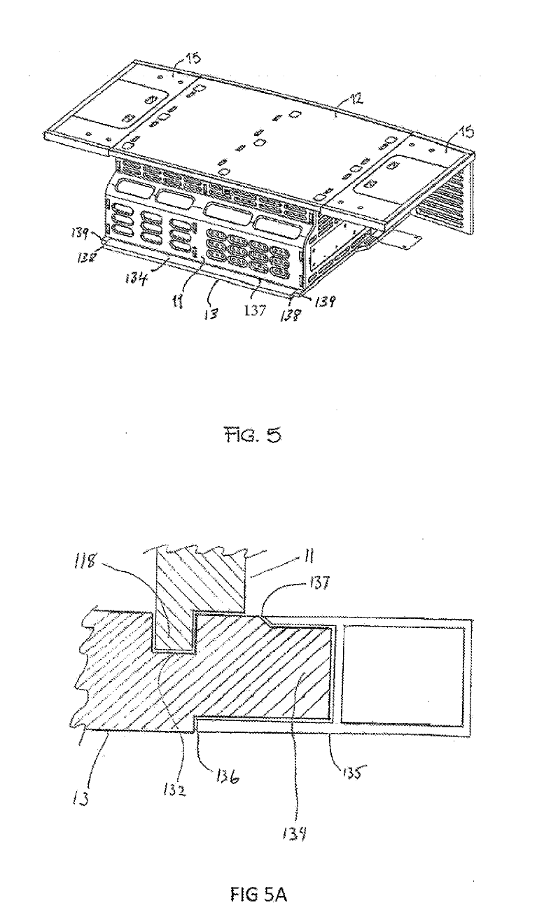

When assembling the carcass 101, the user should first assemble all the divider panels 14 on the bottom panel 13 by inserting the tenons 181 into the corresponding mortises 182 of the bottom panel, and then longitudinally pushing the divider panels 14 until each hook profile is seated in its home position on the profiled face of the barrier portion 1822. Thus, the bottom panel 13 remains stationary while each divider panel 14 is pushed to seat the tenons 181 in the home position in the mortice 182. The rear panel 11 is then assembled with the divider panels with the tenons 181 at the rear edges of the divider panels received in the mortices 182 of the rear panel 11. The rear panel is pushed down to lock the tenons in place—and a longitudinal rib 118 (FIGS. 5A, 13 and 15) on the bottom edge of the rear panel seats in a groove 132 in the upper face of the bottom panel. The top panel 12 is overlaid onto the divider panels 14 to line up the tenons on the divider panels 14 with the mortices 182 in the top panel 12. The tenons 181 must be all received in the top panel 12 before the top panel 12 is pushed so that the tenons 181 in the divider panels 14 seat in the home position in the mortices 182 in the top panel 12.

This structure is very simple to assemble, easy to operate, and rigid in final form. Dismantling is possible if desired but requires individual prising apart of each tenon/mortice pair with a suitable pronged tool.

Seals may be provided to insert into the mortice holes from above the top panel 12 to seal the mortice holes and prevent entry of dirt and other debris.

In this embodiment, there are several sunken grooves 141 (see FIG. 6) on the upper edges of the divider panels 14, and the support beams 17 are placed in the grooves 141 so as to avoid the situation that the beams 17 protrude over the upper edge of the divider panel 14, which would otherwise impair the tenon-mortise joint between the divider panel 14 and the top panel 12.

### Rear Panel

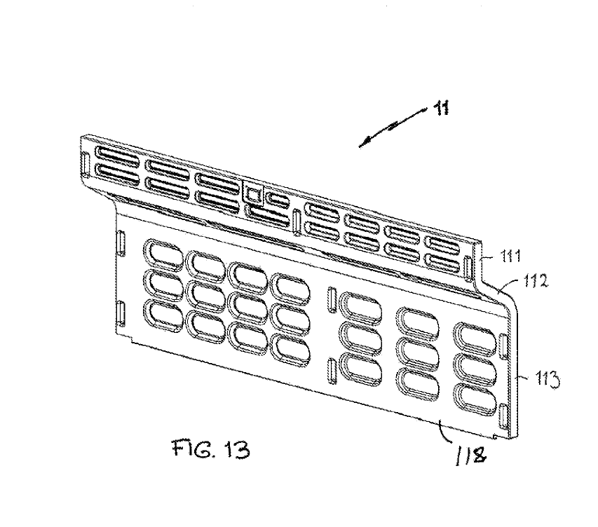

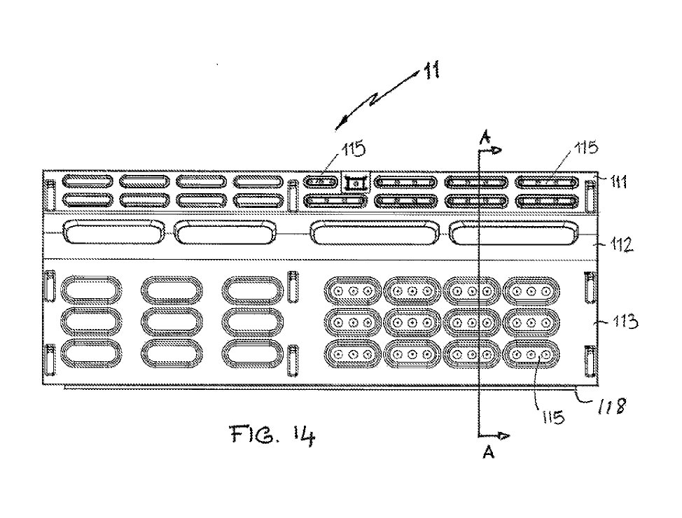

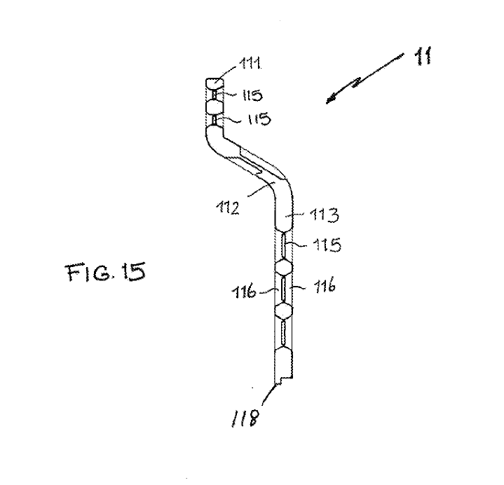

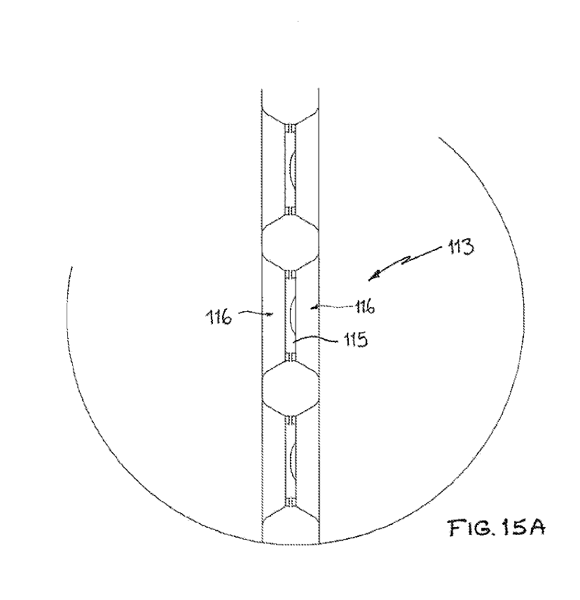

As shown in FIGS. 13 and 14, the rear panel 11 is composed of an upper upright segment 111, an intermediate inclined segment 112, and a lower upright segment 113, which are molded unitarily. This structure makes the storage unit 10 adaptable to the trunk of various motor vehicles, such as recreational or utility vehicles (otherwise known as pickups) and brings about a wider range of application for the storage unit 10.

### Mounting in Vehicle

As shown in FIGS. 5 and 5A, the rear edge of the bottom panel 13 has a margin 134 of reduced thickness, produced by recessing both the top and bottom surfaces from respective transversely extending shoulders 136, 137: bottom surface shoulder 136 is more forward than top surface shoulder 137. This margin 134 does not extend the full width of the panel but only between two symmetrically positioned slots 138 from the rear edge. This leaves respective integral stopper tabs 139 at the rear corners of the panel.

To position the storage unit in a vehicle, reduced thickness margin 134 of bottom panel 13 is pushed with a firm fit into a channel portion of a matching hollow metal section 135 that is fixed across the vehicle floor at the rear edge of bottom panel 13 (FIG. 5A). Stopper tabs 139 then prevent lateral movement along the channel by engaging the ends of the channel. Channel 135 is flush top and bottom with the rest of panel 13. If desired, the unit is fastened into place by suitable clamps or other releasable fasteners at the sides of outer divider panels 14 (not shown).

### Drawers

As shown in FIGS. 1 to 3, the drawers 200 of the vehicle-mounted storage unit proposed in this embodiment may be used for storing articles. Additionally, the drawer 200 may be utilised for placing a vehicle-mounted refrigerator 203 or insulated unit. In this particular embodiment, there is a large drawer 201 for accommodating a refrigerator 203 and a smaller drawer 202 for other articles. While the large drawer 201 is described here, the smaller drawer 202 is of substantially the same construction.

As shown in FIGS. 16 to 18, the large drawer 200 consists of a bottom panel 24, a handle-bearing panel 21 in the front, a rear panel 23 at the back, and two upright panels 22 on each side. A clearance may be provided between the upper edge of the handle-bearing panel 21 and the upper edge of the carcass 101. The clearance would not only prevent fingers being nipped due to incorrect operation, but would also extend operating space when placing a car refrigerator in the drawer 201.

The handle-bearing panel 21 is provided with a handle 211 which is lockable.

As shown in FIGS. 20, 24 and 26, the rear panel 23 is provided with removable ventilation pieces 230, designed for promoting heat transfer of the refrigerator 203. The removable ventilation pieces 230 are described further below.

As shown in FIG. 18, the front edge of the upright panel 22 is provided with first tenons 223, and the back edge provided with second tenons 224 and the lower edge is provided with third tenons 225. There are first mortises 212 at the front of the handle-bearing panel 21, three on each side, which match with the first tenons 223. The handle-bearing panel 21 is connected to the upright panels 22 through mortise-tenon joints. Front plates 213 disguise these mortice-tenon joints.

There are second mortises 23a on the rear panel 23 which match with the second tenons 224 on the upright panel 22. There are third mortices 241 on the bottom panel 24 which match with the third tenons 225 of the upright panel 22. The bottom panel 24 and the rear panel 23 are thus connected to the upright panels 22 through mortise-tenon joints.

The configuration of the tenon projections and the mortice holes and surrounds is the same for the drawers as that described above for the carcass 101 in connection with FIGS. 11 and 12. The resulting mortice-tenon joints are therefore the same.

The drawer may be provided with a stopper or limiting part engaging with a corresponding part on the carcass 101 to avoid the drawers from being excessively pushed into or pulled out of the storage compartments due to a force or accident.

### Drawer Slides

As shown in FIGS. 16 to 19, each upright panel 22 of the large drawer 201 is provided with a reinforcing plate 221 on its internal side, and a protruding slide 222 on its external side.

As shown in FIG. 6, the divider panel 14 is provided with a slide track 142 that are mounted on the sides of the divider panel 14. The slide tracks 142 also improve the strength of the storage compartments.

Rollers 226 are mounted on the protruding slide for rolling engagement with the slide track 142. The rollers 226 enable the drawer 201 to be pulled or pushed smoothly in the storage compartment, and it is very convenient to operate.

### Structure of Panels

FIGS. 20, 24 to 26A illustrate the unitary hollow structural form of a panel 23 constructed from plastic material e.g. polypropylene, using blow-moulding so the panel is of low weight and easy to manufacture. The panel illustrated is the rear panel 23 of the large drawer 201. However, the arrayed recess structure described below is similarly applied to all of the panels used in the storage unit 10. These removable pieces 230 in the recesses 237 provide ventilation openings when the large drawer 201 is used to house a refrigerator 203. These removable pieces 230 may be selectively removed by the end user. The feature of the removable ventilation pieces 230 may also be applied to the rear panel 11 of the carcass 101. The divider panels 14 in the carcass 101 may also have removable pieces within at least some of the recesses.

As shown in FIG. 26, the unitarily-molded panel 23 is shaped to include an S-bend defining an upper portion 234, an inclined portion 235 and a lower portion 236. The panel is composed of an first wall 232 and an second wall 233 which follow the contours of the S-bend. The outer surface of the second wall 232 is planar, apart from the S-shape.

There is a cavity 233 enclosed by the first wall 231 and second wall 232, which reduces the overall weight of the panel 23.

The outer surface of the first wall 231 is provided with an array of recesses 237 that are arranged at regular intervals transversely and longitudinally and sunken into the cavity 233. Each recess 237 is of rectangular or slotted shape with generally rounded ends as shown in FIG. 24. Each portion 234, 235 and 236 has an outer surface of the first wall 231 which is a plane surface.

The inner surface of the first wall in the region of the recess 237 may be closely connected to the second wall 232, or there a clearance may be provided between them. The cavity 233 is thus punctuated by the recesses 237.

Preferably, as shown in FIG. 20, the recesses 237 are arranged as a rectangular array with a number of transverse and longitudinal rows. In the rear panel 23 of the drawer 201 as shown, the lower panel portion 236 has an array of 12 recesses 237, 4 across and 3 down. The inclined panel portion 235 has an array of 4 recesses 2313, 2×2.

In the lower panel portion 234, there is a transverse 2311 or longitudinal ridge 2312 on the first wall 231 between any two of the transverse or longitudinal recess rows. The transverse ridges 2311 and longitudinal ridges 2312 play a connecting and supporting role, and the transverse ridge 2311 has the same width as the longitudinal ridge 2312, leading to uniform load distribution across that portion 236 of the panel 23. The transverse and longitudinal ridges on the hollow structure greatly improve the bearing capacity of the panel 23. When the recess array is in other non-rectangular forms, various shapes of ridges can be obtained to meet diverse demands.

Preferably, the transverse dimension of the recess 237, across the width of the slotted or rectangular recess 237 is shorter than the longitudinal dimension to further improve the stability of the panel. The transverse dimension corresponds to the direction of loading of the panel 23.

The upper panel portion 234 of the rear panel 23 has a scooped cut-out 238 between two side portions 239. The scooped cut-out 238 allows for air flow between the inside of the drawer 201 and the inside of the compartment in the carcass 101 which houses the drawer 201. The two side portions 239 each provide for a mortise hole 23a for attachment to the adjacent upright panels 22 of the drawer.

### Removable Pieces in the Rear Drawer Panel

As illustrated in FIGS. 26 and 26A, some of the recesses 237 in the rear panel 23 are removable to create ventilation or cable openings. The pieces 230 in the recesses 237 in the lower panel portion 236 are all intended to be removed and are provided with markings in the form of indentations 2310 to indicate their special removable nature. The 4 recesses 2313 in the inclined panel portion 235 are not intended to be removed.

The first and/or second walls are shaped to define the removable piece 230. The shape is created by the blow-moulding dies (not shown). The recesses 237 are defined by one or more side walls 2315 formed from depressing the first wall 231 into the recess 237. The removable piece 230 has a scored perimeter formed by the blow-moulding dies forming a depression 2314 surrounding the removable piece 230, with the resultant material thickness of the panel 23 around the end wall being thin and therefore frangible or breakable. In the depression 2314, the first wall 231 meets or is closely proximate to the second wall 232. The blow-moulding dies also form the indentations 2310 in the first wall 231. The first wall 231 is therefore push into the cavity 233 to form the recess 237 while the second wall 232 remains substantially planar. However, in other panels such as the rear panel 11 and the divider panels 14 of the carcass 101 and the side panel of the drawer, both the first wall and the second wall may be depressed by the blow-moulding dies to form the removable piece.

This makes the end walls easy to remove, either by simple manual detachment, or using a hand-tool such as a knife or punch.

The other recesses 2313 in the inclined panel portion 235 are not intended to be removed and do not include a removable piece bordered by a depression. Accordingly, theses recesses 2313 contain no markings.

### Removable Pieces in the Rear Panel of the Carcass

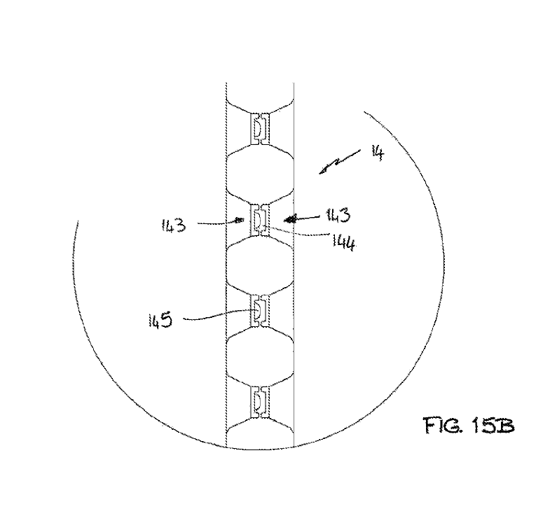

Similarly, the rear panel 11 of the carcass 101 as shown in FIGS. 13 to 15A also contains removable pieces 115 which are likewise marked as removable. In the rear panel 11, aligned recesses 116 are formed in the outer surface of both side walls as can be seen in the cross-section of FIGS. 15 and 15A. Thus, each removable piece 115 is centrally disposed between the two recesses 115. Similarly, each removable piece 115 is bordered by a score line, groove or notch rendering the connection as frangible or breakable so that the removable pieces 115 can be easily removed.

The removable pieces are disposed in the lower portion 113 and the upper portion 111 but only on the side of the rear panel 11 which is adjacent the large drawer 201. This is because the large drawer 201 is intended to house the refrigerator 203 for which ventilation is required.

While only some of the recesses in the panel 11 are intended to have removable pieces, it is possible that all of the recesses in the panel 11 could have removable pieces.

### Removable Pieces in the Divider Panels of the Carcass

Additionally, as shown in FIG. 15B, some of the recesses 143 formed in the divider panels also have removable pieces, at a substantially central depth relative to the first and second walls of the divider panel 14. These removable pieces 144 are likelwaise marked 145 as removable.

### Removable Pieces in the Upright Panels of the Large Drawer

Additionally, the upright panels 22 of the large drawer 201 also contain removable pieces 227 within some of the recesses 228 as marked on FIGS. 21 and 22. FIGS. 23-23B illustrate the particular form.

The foregoing describes only one embodiment of the present invention and modifications may be made thereto without departing from the scope of the present invention.

1. A blow-molded plastic panel for a flat-packable storage container, at least a portion of said panel having a substantially planar extent, the panel portion having first and second outer wall surfaces substantially aligned with the substantially planar extent of the panel portion,
wherein one or more cavities lies between the first and second outer wall surfaces, and
the panel portion is provided with a plurality of recesses in the first outer wall surface which are recessed in the direction of the second outer wall surface, said recesses being spaced longitudinally and transversely relative to the substantially planar extent of the panel portion.

2. The blow-molded panel as claimed in claim 1 wherein the panel portion is provided with a first wall and a second wall which in the blow molding process are molded in generally spaced disposition from each other and the first wall provides the first outer wall surface and the second wall provides the second outer wall surface.

3. The blow-molded panel as claimed in claim 2 wherein the first and second walls meet at the recesses.

4. The blow-molded panel as claimed in claim 2 wherein the first and second walls are spaced with a clearance at the recesses.

5. The blow-molded panel as claimed in claim 1 wherein said recesses are arranged in an array on or across the substantially planar extent of the panel portion.

6. The blow-molded panel as claimed claim 5 wherein the array is a rectangular array with a number of transverse and longitudinal rows of recesses defining a transverse ridge between any two of the transverse rows and a longitudinal ridge between any two of the longitudinal recess rows.

7. The blow-molded panel as claimed in claim 6 wherein the said transverse ridge has the same width as the longitudinal ridge.

8. The blow-molded panel as claimed in claim 1 wherein each recess is rectangular in shape with a longitudinal extent and a transverse extent, the transverse extent being shorter than the longitudinal extent and being arranged such that the transverse extent is subject to loading in use.

9. The blow-molded panel as claimed in claim 1 wherein the first outer wall surface is substantially flat.

10. The blow-molded panel as claimed in claim 1 wherein at least some of the recesses in the panel portion have an associated detachable portion.

11. The blow-molded panel as claimed in claim 10 wherein the panel portion is provided with a first wall and a second wall which in the blow molding process are molded in generally spaced disposition from each other and the first wall provides the first outer wall surface and the second wall provides the second outer wall surface, wherein each detachable portion is defined by the shape of the first wall and/or the second wall.

12. The blow-molded panel as claimed in claim 10 wherein each detachable portion is defined by a score line, groove, depression or one or more notches.

13. The blow-molded panel as claimed in claim 10 wherein each detachable portion is formed to have a frangible connection with the remainder of the panel.

14. The blow-molded panel as claimed in claim 10 wherein predetermined ones of the plurality of recesses include said detachable portion whereas others of the plurality of recesses do not include said detachable portion.

15. The blow-molded panel as claimed in claim 10 wherein said detachable portions are marked.

16. The blow-molded panel as claimed in claim 1 wherein there is a second panel portion having a substantially planar extent, the second panel portion having third and fourth outer wall surfaces substantially aligned with the substantially planar extent of the second panel portion,
wherein the panel portion is provided with a plurality of recesses in the third outer wall surface which are recessed in the direction of the fourth outer wall surface, said recesses being spaced longitudinally and transversely relative to the substantially planar extent of the second panel portion.

17. The blow molded panel as claimed in claim 16 wherein the second panel portion shares the cavity with the first panel portion.

18. A storage unit comprised of a plurality of panels as claimed in claim 1 wherein, of the plurality of recesses, selected ones in the rear of the storage unit have said detachable portions.
